(19) United States
(12) Patent Application Publication
(10) Pub. No.: US 2012/0184173 A1
(43) Pub. Date: Jul. 19, 2012

(54) METHOD FOR PRODUCING A DISCHARGE LAMP

(75) Inventors: Lambert Frye, Steinheim (DE); Claus Pfaller, Walting-Inching (DE); Christoph Steidl, Eichstaett (DE)

(73) Assignee: OSRAM AG, Muenchen (DE)

(21) Appl. No.: 13/498,148

(22) PCT Filed: Sep. 8, 2010
(86) PCT No.: PCT/EP2010/063147

§ 371 Date: Mar. 26, 2012

(30) Foreign Application Priority Data
Oct. 2, 2009 (DE) 10 2009 048 126.5

(51) Int. Cl. H01J 9/32

(52) U.S. Cl. 445/29

(57) ABSTRACT

In various embodiments, a method for producing high-pressure discharge lamp including discharge vessel sealed off on two sides, discharge vessel having two ends with an electrode system with foil, an electrode with shaft and an outer current lead-in, by: providing a quartz glass discharge vessel having two still open, tubular ends; introducing an electrode system into the open first end and, if necessary also into the second open end; optionally flushing the discharge vessel; heating first open end at the level of the shaft, at no less than two selected points lying on a circumference and enabling centering; provisional fixing in place of the shaft by means of a bossing process, wherein fingers made of quartz glass are formed at tubular first end and extend toward shaft; heating and fuse-sealing the sealing-in region, comprising the foil and the fingers, at the first end, thereby sealing off first end.

### TECHNICAL FIELD

The invention proceeds on the basis of a method for producing a discharge lamp according to the preamble of claim 1. Such lamps are in particular high-pressure discharge lamps having a vessel made of quartz glass and a metal halide fill.

### BACKGROUND ART

High-pressure discharge lamps sealed at both ends and having an electrode support to provide better fixing are known from U.S. Pat. No. 5,663,607 and U.S. Pat. No. 4,038,578. However, said lamps require additional components.

### SUMMARY OF THE INVENTION

An object of the present invention is to disclose a method by means of which the misalignment of electrodes can be prevented in a simple manner without additional components.

This object is achieved by means of the characterizing features of claim 1.

Particularly advantageous embodiments are disclosed in the dependent claims.

The problem of electrode misalignment in lamps sealed at both ends is conventionally solved by means of special pinching jaws. In the case of a fusing or sealing-in process it is possible to attempt to apply a special flame guidance technique during manufacture.

Electrode systems containing foils are typically inserted into the ends centrally with respect to the longitudinal axis of the discharge vessel. There, they can be centered in principle by means of a retaining system, a clip or suitably shaped current lead-in. They can, however, also be fixed in position and held in alignment in the discharge vessel made of quartz glass by means of suitable geometric shaping of the sealing-in region of the ends of the discharge vessel in their x-direction, defined in this case as the wide side of an electrode system, and y-direction, defined in this case as the narrow side of the foil.

Normally the alignment is lost at the time of the first contact between Mo foil and bulb glass as a result of adhesion effects and differences in temperature distribution.

By fixing in place the pin or shaft of the electrode, which in particular has a head on the discharge side, prior to the sealing-in process by means of two or more centering bosses in the tubular end it is possible to maintain the position of the electrode during the sealing-in process. As a result, the misalignment of the electrode with respect to the reference position on the longitudinal axis is considerably reduced. The deviation from the reference position is improved by a factor of 5 to 10 compared to conventional fused seals. Scattering in respect of a desired light color is also greatly decreased as a result. A further advantage is that from the statistical perspective a lower temperature at the bulb wall is achieved, which in turn leads to a longer useful life. The bossing of the end is a special form of pinching in which the tubular end is not sealed off. A technology of said type is only intended for the provisional securing and fixing of the electrode shaft, although there nonetheless remains the possibility of evacuation or gas replacement via the thus created constriction point toward the interior of the discharge vessel.

The production process proceeds in such a way that initially a bulb tube with open ends and externally retained electrode systems is inserted into a sealing machine. The bulb is subsequently flushed through the open ends. One tubular end is then heated up at two or more points lying on a circumference of the tube. The shaft of the electrode is thereupon fixed in position by means of the bossing process, specifically at one end. In the next step the first sealing-in process is completed. A fill can then be introduced into the discharge vessel through the end that is open at one side. The second bossing process is then performed and afterward the sealing-in completed, with the result that the foil is completely encased by quartz glass.

In this solution the wall thickness of the tubular end can be in the normal range of typically 1 to 3 mm.

The electrode systems are held at the shaft ends by the “fingers” of the bosses until the sealing-in process takes place. During the heating, glass transition temperatures in the order of 2000° C. are reached at the points where the bossing is applied.

Initially, incorporating the bosses is comparable with a similar process for permanently fixing the light-emitting element of halogen incandescent lamps, as known already from EP 446 458. In contrast thereto, the boss region can be fused over at a later stage in order to complete the sealing-in operation. Furthermore, the bossed region takes on the function effectively of a “thermal brake” during the sealing-in process. Due to the thermal contact between foil and glass that is already present here the sealing-in process is terminated prematurely, with the result that in most cases slight dimples remain in the area of the seal. Furthermore, the effect of this, as it were, two-stage fusing/sealing-in process is that the finished discharge vessel has a higher mechanical strength than in the case of a one-stage fusing/sealing-in process because no such great thermal stresses remain.

Preferably two bosses disposed opposite each other or alternatively three bosses evenly distributed around the circumference of the tube are used.

### BRIEF DESCRIPTION OF THE DRAWINGS

The invention shall be explained in more detail below with reference to a number of exemplary embodiments taken in conjunction with the figures, in which:

FIG. 1 shows a high-pressure discharge lamp;

FIG. 2 shows a discharge vessel with fitted electrode system;

FIG. 3 shows a detail of the end of the bulb with electrode system aligned therein (FIG. 3a) and associated section (FIG. 3b); and

FIG. 4 shows the same detail following the bossing process (FIG. 4a) and associated section (FIG. 4b).

### PREFERRED EMBODIMENT OF THE INVENTION

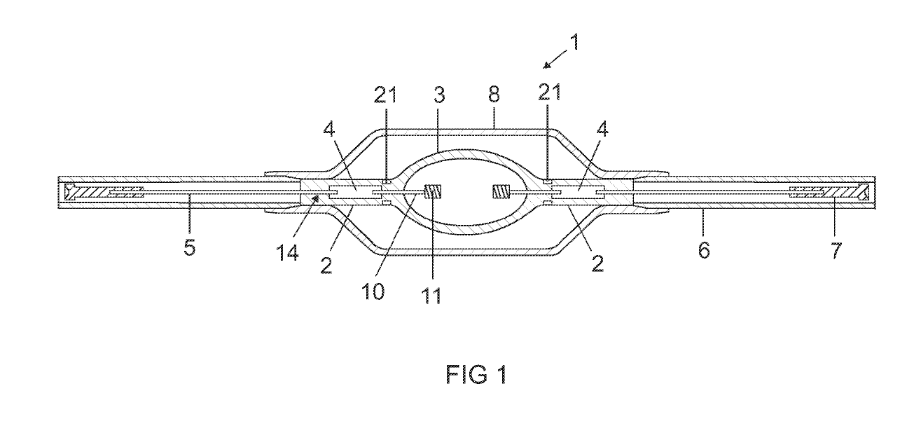

FIG. 1 shows a metal halide lamp 1 which is sealed off by means of fused seals 2. The lamp in question is a 150 W lamp having a bulbous discharge vessel 3. The fused seals 2 have a diameter of approx. 5 mm. Fixed in place in the fused seal is an electrode system 14 including a current lead-in 5, a foil 4 and a pin-like electrode, including a shaft 10 and a head part 11, which projects into the discharge volume. A tube section 6 integrally adjoins the end of the fused seal. A base part 7 is integrated in the tube section.

The discharge vessel is surrounded by an outer bulb envelope 8 which is substantially cylindrical in shape. This tapers toward the tube section 6. The fill is a conventional metal halide filling for general lighting applications as is known per se. The base 7, which is connected to the outer current lead-in 5, is retained in the extension of the tubular end.

Despite being subject to heavy loading, a compact lamp of such type achieves a useful life of at least 6000 hours, in particular, given an optimal design, even more than 12000 hours.

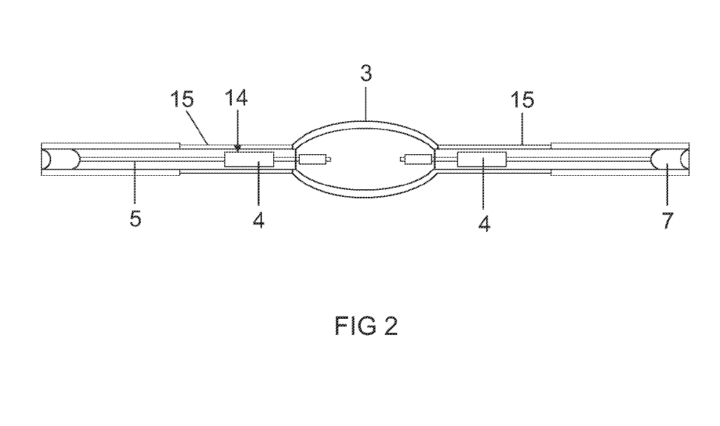

FIG. 2 shows a schematic view of a discharge vessel 3 of said type, wherein the two ends 15 are still untreated and embodied as tubular parts. Two electrode systems 14 are inserted in the tubular ends. The front part of the tubular end may in this case be reduced in thickness in preparation for the fusing/sealing-in process.

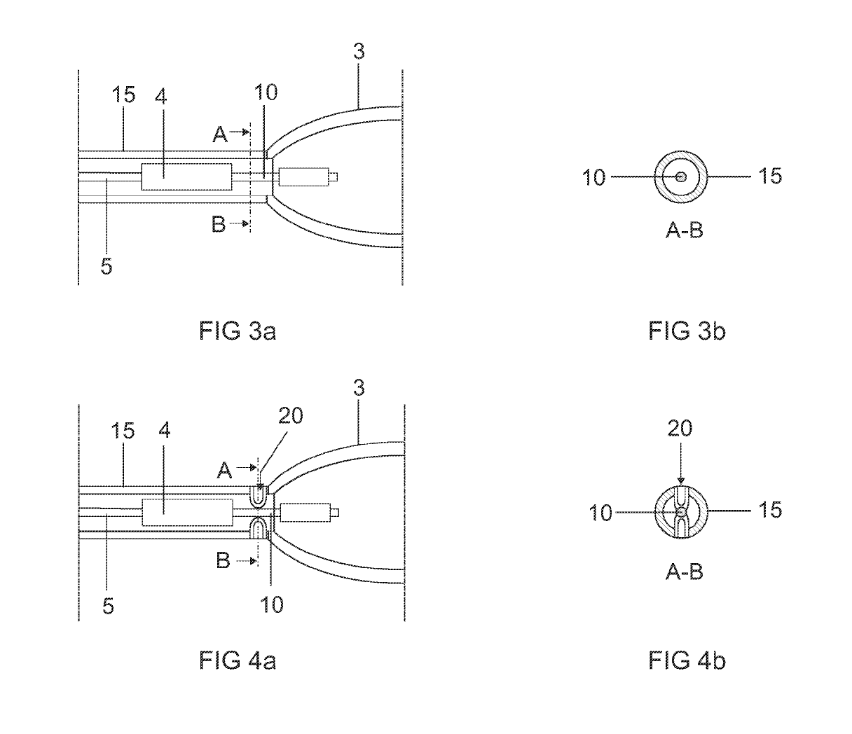

FIG. 3 shows a detail view of one end 15 (FIG. 3a) and the associated cross-section (FIG. 3b), wherein sufficient space for pumping and flushing remains in the end 15.

A component of this type consisting of discharge vessel and electrode system is inserted into a sealing machine. The still open bulb is subsequently flushed by way of the ends, as is known per se, typically with inert gas. The tubular end is then heated, either at both ends or alternatively initially only at one end 15, at two points disposed opposite each other at the level of the subsequent sealing-in region.

FIG. 4 shows that now, in a similar manner to that described in EP 446458, the electrode shaft 10 is centered by means of two fingers 20 (FIG. 4a). It can be seen in the cross-section shown in FIG. 4b that here too there again remains sufficient space in the tube 15 for further pumping and flushing as well as filling.

The filling process is first completed before a conventional sealing-in process is now performed, wherein remnants of the fingers 20 may remain as dimples 21 in the region of the end (see FIG. 1).

Next, the discharge vessel can be covered by an outer bulb envelope 8, as shown in FIG. 1. Details of the production process in this regard are disclosed for example in DE-A 103 25 554.

Essential features of the invention, presented in the form of a numbered list, are:
1. A method for producing a high-pressure discharge lamp comprising a discharge vessel which is sealed off on two sides, the discharge vessel having two ends in each of which are retained an electrode system with foil, an electrode with shaft and an outer current lead-in, characterized in that the following method steps are applied:
   providing a discharge vessel made of quartz glass and having two still open, tubular ends;
   introducing an electrode system at least into the open first end, if necessary also into the second open end;
   flushing the discharge vessel if necessary;
   heating the first open end at the level of the shaft, specifically at no less than two selected points lying on a circumference and enabling centering;
   provisional fixing in place of the shaft by means of a bossing process, wherein fingers made of quartz glass are formed at the tubular first end and extend toward the shaft;
   heating and fuse-sealing the sealing-in region, including at least the foil and the fingers, at the first end, thereby sealing off the first end.

2. The method as claimed in claim 1, characterized in that two fingers are used per shaft.

3. The method as claimed in claim 1, characterized in that the discharge vessel is fabricated from quartz glass.

4. The method as claimed in claim 1, characterized in that after the first end of the discharge vessel has been sealed off, the discharge volume is filled with metal halides introduced through the still open second end.

5. The method as claimed in claim 4, characterized in that after the filling stage an electrode system is optionally introduced into the still open second end, and in that the still open second end is sealed off in a similar manner to the first end.

6. The method as claimed in claim 4, characterized in that before the second end is sealed off, at the latest after the filling stage, an electrode system is introduced into the still open second end.

1. A method for producing a high-pressure discharge lamp comprising a discharge vessel which is sealed off on two sides, the discharge vessel having two ends in each of which are retained an electrode system with foil, an electrode with shaft and an outer current lead-in, comprising:
providing a discharge vessel made of quartz glass and having two still open, tubular ends;
introducing an electrode system at least into the open first end, if necessary also into the second open end;
flushing the discharge vessel if necessary;
heating the first open end at the level of the shaft, specifically at no less than two selected points lying on a circumference and enabling centering;
provisional fixing in place of the shaft by means of a bossing process, wherein fingers made of quartz glass are formed at the tubular first end and extend toward the shaft;
heating and fuse-sealing the sealing-in region, comprising at least the foil and the fingers, at the first end, thereby sealing off the first end.

2. The method as claimed in claim 1, wherein two fingers are used per shaft.

3. The method as claimed in claim 1, wherein the discharge vessel is fabricated from quartz glass.

4. The method as claimed in claim 1 wherein after the first end of the discharge vessel has been sealed off, the discharge volume is filled with metal halides introduced through the still open second end.

5. The method as claimed in claim 4, wherein after the filling stage an electrode system is optionally introduced into the still open second end, and in that the still open second end is sealed of in a similar manner to the first end.

6. The method as claimed in claim 4, wherein before the second end is sealed off, at the latest after the filling stage, an electrode system is introduced into the still open second end.
